(19) United States
(12) Patent Application Publication
(10) Pub. No.: US 2003/0005068 A1
(43) Pub. Date: Jan. 2, 2003

(54) System and method for creating a virtual supercomputer using computers working collaboratively in parallel and uses for the same

(76) Inventors: Ronald H. Nickel, Alexandria, VA (US); Igor Mikolic-Torreira, Alexandria, VA (US)

Correspondence Address: Michele M. Burris, SHAW PITTMAN, 1650 Tysons Boulevard, McLean, VA, 22102-4859, US

(21) Appl. No.: 09/950,067

(22) Filed: Sep. 12, 2001

Related U.S. Application Data
(60) Provisional application No. 60/258,354, filed on Dec. 28, 2000.

(51) Int. Cl. G06F 15/16; G06F 9/00

(52) U.S. Cl. 709/208; 709/102

(57) ABSTRACT

A system and method for solving a computationally intensive problem using a virtual supercomputer comprising a plurality of multipurpose workstations. The virtual supercomputer and application software for solving the computationally intensive problem are adapted for minimum impact on the multipurpose workstations which may be used for performing other tasks as needed by primary users. The computationally intensive problem is solved by the virtual supercomputer using any excess computational resources available on the multipurpose workstations.

This application claims the benefit of U.S. Provisional Application No. 60/258,354, filed Dec. 28, 2000, which is herein incorporated by reference in its entirety.

This invention was made with Government support under contract no. N00014-00-D-0700 awarded by the Office of Naval Research. The Government has certain rights in the invention.

### BACKGROUND

1. Field of the Invention

The present invention relates to a system and method for creating a virtual supercomputer using computers working collaboratively in parallel and uses for the same. More specifically, the present invention pertains to an on-demand supercomputer system constructed from a group of multipurpose machines working collaboratively in parallel. The machines may be linked through a private network, but could also be linked through the Internet provided performance and security concerns are addressed.

2. Background of the Invention

The present invention provides an on-demand supercomputer comprising a group of multipurpose machines working collaboratively in parallel. As such, the present invention falls in the category of a “cluster” supercomputer. Cluster supercomputers are common at the national labs and major universities. Like many other cluster supercomputers, the present invention can use the freely available “Parallel Virtual Machine (PVM)” software package provided by Oak Ridge National Laboratories (ORNL), Oak Ridge, Tenn., to implement the basic connectivity and data exchange mechanisms between the individual computers. Other software applications for establishing a virtual supercomputer may be used, provided that the software applications allow reconfiguration of the virtual supercomputer computer without undue interference to the overall operation of the virtual supercomputer. The present invention also uses proprietary software, as described herein, to provide various capabilities that are not provided by PVM.

Virtual supercomputers known in the art comprise job control language (JCL) processors such as the Sun Grid Engine Software (GES), from Sun Microsystems, Palo Alto, Calif., for example. In particular, with a JCL processor product for networked computers such as GES, a user submits a job (a task to be executed) to the JCL master. The JCL master then uses sophisticated rules for assigning resources to find a workstation on the network to perform the task. The task could be a single program or many programs. The JCL master will assign each program in the task to individual processors in the network in such a way that the total time to complete all the programs in the task is minimized. The GES does not, however, provide support for parallel processing in that it does not provide special mechanisms for information to be shared between the programs that might change their computations.

To the extent that it is possible for a user to develop GES applications that do parallel processing, the user must find ways to exchange data between jobs running on separate machines. Furthermore, it appears that GES has no way of knowing that the jobs running on separate computers are part of a coherent whole. It follows that if one of the parallel processing jobs drops for any reason, GES will not know that it has to do something besides simply putting that particular job “back in the queue”. This would make fault tolerance for a parallel-processing application under GES exceptionally hard to develop.

### SUMMARY OF THE INVENTION

A method for solving a computationally intensive problem using a plurality of multipurpose computer workstations. The method comprising the steps of: (a) building a parallel virtual machine comprising a master computer and at least one slave computer, wherein the at least one slave computer is selected from the plurality of multipurpose computer workstations; (b) dividing the computationally intensive problem into a plurality of task quantum; (c) assigning to the at least one slave computer at least one task quanta selected from the plurality of task quantum; (d) completing on the at least one slave computer the at least one task quanta; (e) receiving on the master computer a result provided by the at least one slave computer; and repeating steps (c), (d) and (e) until the computationally intensive task is completed.

In contrast to known virtual super computers such as GES, the present invention involves running a single program across multiple processors on the network. The master of the present invention not only assigns work to the processors, it uses information sent by the slave processors to direct the work of all of the processors in attacking a given problem. In other words, the programs in a task are not just sent off to run independently on processors in the network.

The differences between the present invention, conventional computer networks and networked computers controlled by GES may be illustrated by way of analogy to the handling of customer queues. Consider, for example, customers coming to a department of motor vehicles (DMV) for a variety of transactions such as licensing, vehicle registration and the like.

Conventional computer networks would be like a DMV where each teller has their own queue of customers, and the tellers are dedicated to a single kind of transaction (e.g., licenses, registrations, etc). This is very inefficient because at times one teller will have a very long queue and the other tellers will have nothing to do (e.g., everyone wants to renew licenses, but the registration teller has nothing to do).

GES is like a DMV having a bank of tellers and a single queue. Tellers can handle a wide range of transactions (but not necessarily all transactions). When you get to the front of the queue, you go to the first available teller that can handle your transaction. This is far more efficient and allows greater use of the resources at DMV.

The virtual supercomputer of the present invention is like a DMV where when you move in from out of state, handing all your out-of-state paperwork to the first person you see and having all tellers (or as many as needed) process your license, titles, registrations, address changes, etc. simultaneously. Furthermore, the tellers would automatically exchange information as required (e.g., the license teller passing your SSN to the title and registration tellers; the title teller passing the VIN and title numbers to the registration teller, etc.). In no longer than it would take to wait for just the license, you would be handed a complete package of all your updated licenses, registrations, etc.

Because each computer must perform a variety of tasks (unlike the virtual supercomputer of the present invention), the GES requires substantial loading of software on each workstation that will participate in the grid. In contrast, the concept requires a minimal change to the registry and installation of a daemon so that PVM communications can be established with the workstation.

The present invention is a supercomputer comprising a single dedicated computer (called the master computer) that coordinates and controls all the other participating computers. The formation of the supercomputer is initiated by executing the PVM master software on the master computer. The master computer will form a supercomputer by establishing connections with as many other computers as possible (or as explicitly directed by the supercomputer user). Each participating computer downloads software, data, and tasks related to the particular problem to solve as directed by the master computer.

The participating computers are preferably ordinary multipurpose computers configured with the Windows NT/2000 operating system. This operating system is common throughout both government and private industry. All that is required to make a Windows NT/2000 computer capable of participating in supercomputing according to the present invention are a few simple changes to the Windows NT/2000 Registry and the installation of remote-shell software (relatively inexpensive commercial purchase; under $5,000 for a world-wide site license). The present invention is not, however, limited to Windows NT environments and, indeed, can be adapted to operate in Linux, Unix or other operating system environments.

The supercomputer of the present invention has several features that make it unique among all the cluster supercomputers. These features are.

Participating computers are ordinary multipurpose computers that are not physically dedicated to tasks related to the supercomputer. All known cluster supercomputers have dedicated participating computer (e.g., PCFARMS at Fermi National Laboratory, or Beowulf clusters developed by the National Aeronautics and Space Administration). That is, a number of computers are placed in a room, they are wired together, and the only thing they do is function as part of the cluster supercomputer. In contrast, the participating computers used in the present invention can be located in individual offices or workspaces where they can be used at any time by individual users. The present invention only requires one single computer that is dedicated to serving as the master computer.

Participating computers can be used concurrently for ordinary multipurpose computing and supercomputing tasks. Not only are the participating computers themselves not physically dedicated, but even when the supercomputer is running the individual computers can be accessed and used by ordinary users. There is no other cluster supercomputer that we know of that can do this.

Participating computers can be removed from the supercomputer while computations are in progress. Very few of the cluster supercomputers that we know of allow changes in the configuration during a computation run. In fact, cluster supercomputers based on the Message Passing Interface (MPI, an alternate to PVM) require the supercomputer to be shut down and re-started if the configuration is changed in any way. It is noted that the Unix-based cluster at Sandia National labs allows the removal of participating computers. In that system, however, participating computers can be removed only until some minimum number of participants is left (the minimum number of participants may vary from problem to problem). If any additional computers beyond the minimum drop out of the supercomputer, the computation will fail. In contrast, when a participating computer drops out of the supercomputer of the present invention, the computational workload is automatically re-distributed among remaining participants and the computations proceed uninterrupted. The supercomputer of the present invention will continue the computational tasks without interruption even if all participating computers are dropped and only the master computer remains.

Participating computers can be added to the supercomputer while computations are in progress and they will be exploited by the in-progress computation. Most PVM-based cluster supercomputers allow participating computers to be added at anytime. However, the added computers are not actually used until the next computation begins. In contrast, the supercomputer of the present invention can make immediate use of any computers added to the supercomputer. The computational workload will be re-distributed automatically to include the newly added computer.

Computers eligible to participate in the supercomputer are automatically detected and added to the supercomputer whenever such computers appear on the network. In effect, the supercomputer of the present invention will automatically seek out, find, and use any eligible computer resources it finds on the network. A computer is eligible if (a) it is configured as a potential participant and (b) the supercomputer user has indicated that the particular computer should be included in the supercomputer. The latter can be done either by providing the master computer with a list of individual computers that should make up the supercomputer or by simply instructing the master computer to use “all available resources.” In contrast, in distributed internet computing, such as project SETI, the individual computers must explicitly signal their availability to the master computer. That is, participation is voluntary, whereas in the present invention, participation is controlled by the master computer.

The supercomputer is highly fault tolerant. If any participating computer exits (e.g., if a hardware or software failure causes the computer to lose communication with the master computer, or if the computer is shut down), the supercomputer of the present invention will automatically detect the loss of the participant and re-balance the computational load among the remaining computers. If the network itself fails, the computation proceeds on the master computer (albeit rather slowly) until the network is restored (at which point the supercomputer automatically detects eligible participating computers and reconnects them). Only if the master computer fails will the computation also fail. In this case the computation must be restarted and the computation proceeds from an intermediate result (so not all computations are lost). Moreover, in the present invention, the robustness of the cluster supercomputer can be bolstered by implementing automatic reboot and restart procedures for the master computer. No known cluster supercomputer is as robust as that of this present invention.

The supercomputer of the present invention also has several features that make it unique from commercial products that allows parallel processing across an existing network of Linux computers. One such product, called Enfuzion, is actually quite different from the supercomputer of the present invention. The problem that Enfuzion is meant to solve is that of the need to run the same application over and over again with slightly different data sets. This is common, for example, in doing Monte Carlo modeling where lots of essentially identical runs are needed to produce useful statistical results. Needless to say, this can be a tedious and time-consuming process. Enfuzion solves this particular need by automatically and simultaneously running the application on each of the computers in the network. So, instead of running the same model 100 times consecutively, Enfuzion can run it once across 100 computers simultaneously. This lets a user obtain 100 model runs in the same time it normally took to do a single run.

This is far less sophisticated than the supercomputer of the present invention. The supercomputer of the present invention can perform the needed calculations as a trivial special case. In addition to the functionality provided by Enfuzion the supercomputer of the present invention can also exchange data across runs on different computers while the computation is in progress. That is, data results derived on one member of the cluster can be directly communicated to other cluster members, allowing the other nodes to make immediate use of the new data. To the best of our knowledge, Enfuzion does not have any way for the runs on different computers to exchange or share data that might affect the course of the computations.

Additionally, with the supercomputer of the present invention the participating computers can work collaboratively to solve a single computational problem. The software that Enfuzion runs on each machine is essentially independent of all the other machines. It is no different than walking up to each computer and starting up the same program on each one (perhaps with different input data for each). All Enfuzion does is automate this process so you don't have to walk from computer to computer. In essence, each is solving its own little problem. The supercomputer of the present invention allows all participating computers to work collaboratively to solve a single problem. The in-progress partial results from one computer can affect the progress of computations on any of the other computers. The programs Enfuzion runs on each computer would run equally well sequentially (they run in parallel simply to save time). In contrast, programs running on the supercomputer of the present invention beneficially interact with other computers in the cluster not only to save time, but to increase the computational capabilities.

### BRIEF DESCRIPTION OF THE DRAWINGS

FIG. 1A is a schematic diagram showing a virtual supercomputer comprising a plurality of multipurpose computers.

FIG. 1B is a schematic diagram showing a configuration used in a master computer of the virtual supercomputer of the present invention.

FIG. 1C is a schematic diagram showing a configuration used in a member computer of the virtual supercomputer of the present invention.

FIG. 1D is a schematic diagram showing how the virtual supercomputer of the present invention reconfigures itself when a member host computer drops out of the virtual supercomputer.

FIGS. 2A and 2B are schematic diagrams showing how the virtual supercomputer of the present invention reconfigures itself when a new member computer joins the virtual supercomputer.

FIG. 3 is a flow chart showing the steps used in one embodiment of the present invention to establish and use a virtual supercomputer to rapidly complete a computationally intensive task.

FIG. 4 is a flow chart showing the steps used in one embodiment of the present invention to establish a virtual supercomputer.

FIG. 5 is a flow chart showing the steps used in one embodiment of the present invention to automatically reconfigure a virtual supercomputer when computer hosts join or exit the virtual supercomputer.

FIG. 6 is a flow chart showing the steps used in one embodiment of the present invention when a host computer attempts to join a virtual supercomputer.

FIG. 7 is a schematic diagram showing a virtual supercomputer comprising a plurality of multipurpose computers and a plurality of sub-master computers.

FIG. 8 is a schematic diagram showing two virtual supercomputers comprising a common pool of multipurpose computers.

### DETAILED DESCRIPTION OF THE INVENTION

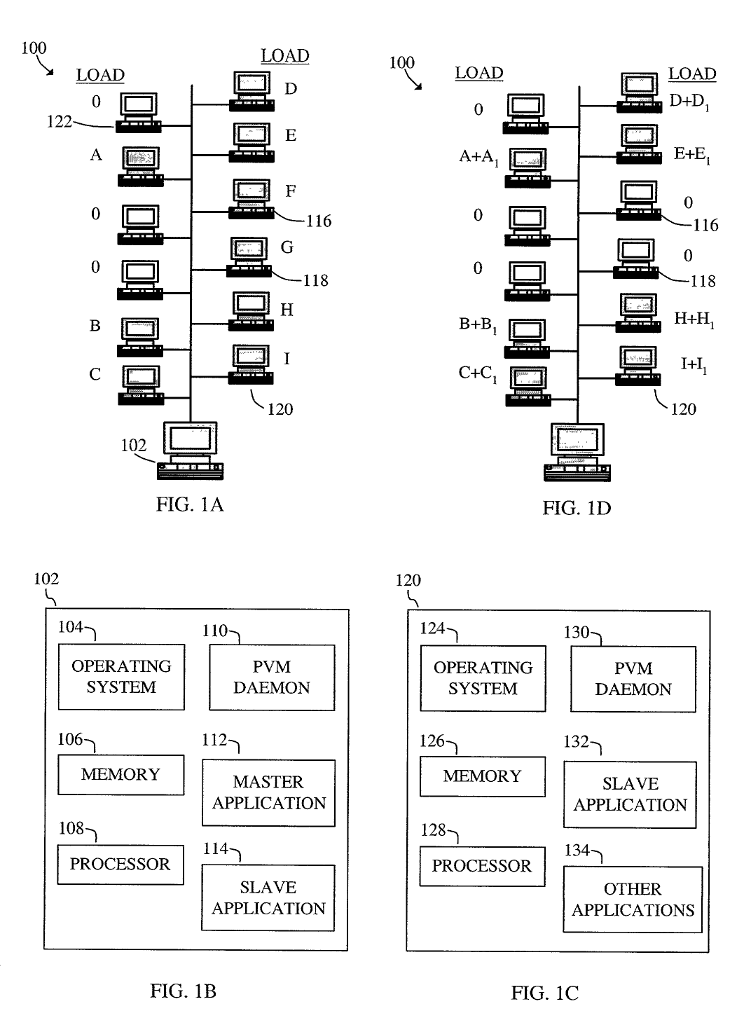

Computer network 100, shown in FIG. 1A, comprises a plurality of computer systems in communication with one another. The communications path may be any network such as, for example, a local or wide area network, or the Internet. The virtual supercomputer of the present invention comprises computers selected from computer network 100. One of the computers in computer network 100 is master computer 102 which serves as the master of the virtual supercomputer. Master computer 102 is a computer system comprising operating system 104, memory 106, central processor 108, parallel virtual machine (PVM) daemon 110, and master application software 112, as shown in FIG. 1B. PVM daemon 110 may be any software application for establishing a parallel virtual machine comprising independent computer systems working in collaboration. PVM daemon 110 controls the communications channels between master computer 102 and other member computers of the virtual supercomputer. In one embodiment of the present invention, PVM daemon 110 is the PVM software provided by ORNL.

Master application software 112 controls the operation of the virtual supercomputer in solving the computationally intensive problem. That is, master application software 112 is responsible for building and managing the virtual supercomputer, for assigning tasks to other member computers in the supercomputer, and for saving results of the computations as reported by the other member computers. Master computer 102 may be any multipurpose computer system. Preferably, master computer 102 is a computer system dedicated to performing tasks as the master for the virtual supercomputer. Master computer 102 also comprises slave application software 114 which performs tasks received from master application software 112.

As noted above, multipurpose computers from computer network 100 are used to build the virtual supercomputer of the present invention. Shaded icons in FIG. 1A designate computers that are members of the virtual supercomputer. That is, for example, computers 102, 116, 118 and 120 among others, are members of the virtual supercomputer. In contrast, computer 122 is not currently a member of the virtual supercomputer shown in FIG. 1A. This convention is used throughout the Figures to distinguish between members and non-members of the supercomputer.

As shown in FIG. 1C, member computers such as member computer 120 comprise operating system 124, memory 126, central processor 128, PVM daemon 130 and slave application software 132. Additionally, computer 120 may comprise other application software 134 allowing a user to perform multiple tasks on computer 120. Such other application software may include, for example, word processing, spreadsheet, database or other commonly used office automation applications, among others. Operating system 124 on member computer 120 need not be the same as operating system 104 on master computer 102. Similarly, operating system 124 on member computer 120 could be different from the operating system used on other member computers, such as for example, member computers 116 or 118. Accordingly, the virtual supercomputer of the present invention may comprise a heterogeneous network of computer systems. In one embodiment of the present invention, PVM daemon 130 and slave application software 132 on member computer 120 are the same as PVM deamon 110 and slave application software 113, respectively, that are implemented on master computer 102.

The virtual supercomputer of the present invention provides mechanisms for automatically reconfiguring itself in the event of a failure of one of the member computers. Similarly, the virtual supercomputer of the present invention provides mechanisms for adding additional member computers as they become available. In this manner, the virtual supercomputer of the present invention is a highly robust system for completing the computationally intensive problems presented with minimal intervention from a system administrator. Moreover, the robustness provided by the virtual supercomputer of the present invention allows member computers to freely join or leave the virtual supercomputer according to the member computers availability for assuming a role in the computations. Accordingly, the virtual supercomputer of the present invention may take full advantage of the excess processing capabilities of member computers without adversely impacting the users of those computers.

The schematic diagrams shown in FIGS. 1A and 1D illustrate how the virtual supercomputer of the present invention reconfigures itself when a member computer drops out of the virtual supercomputer. The processing loads for each member computer are as shown in FIG. 1A. The actual processing load on each member computer is dependent on the tasks assigned to each computer by master computer 102. The load may be based on an estimated instructions per time unit, or in terms of task quantum assigned or some other unit indicating the processing capacity of the member computer which is being, or will be, consumed as part of the virtual supercomputer. For example, the processing load on member computer 116 is represented by the symbol “F,” where F represents the capacity (in whatever units are chosen) of computer 116 devoted to solving the computationally intensive problem. Similarly, the processing load on member computer 120 is I, which may or may not be the same load as F. The processing load on computer 122 is shown as zero in FIG. 1A because that computer is not currently a member of the virtual supercomputer.

If a member computer drops out of the virtual supercomputer the load must be redistributed among the remaining member computers. For example, in FIG. 1D, computers 116 and 118 have dropped out of the virtual supercomputer, as evidenced by their processing loads dropping to zero. In this case, the loads F and G, formerly assigned to computers 116 and 118, respectively, must be reallocated among the remaining member computers. As shown in FIG. 1D, the load on each remaining computer is adjusted. In one embodiment, the incremental load assigned to each remaining member computer, i.e., A₁, B₁, etc., is evenly distributed. That is, A₁=B₁=C₁, and so on. In another embodiment, the incremental load on each remaining member computer is proportional to the previously assigned load. For example, I₁, the incremental load on member computer 120, is given by:

$${I}_{1} = \frac{I}{T} \times ( F + G ) ,$$

where I is the load previously assigned to member computer 120, F is the load previously assigned to computer 116, G is the load previously assigned to computer 118, and T is the total load assigned to remaining member computers prior to redistribution of the load. Another way of assigning the loads to each computer is to make the loads assigned proportional to the relative speeds of the computers. In any event, the sum of the incremental loads for each system is equal to the load formerly assigned to the dropped computers. That is, F+G =A₁+B₁+C₁+D₁+E₁+H₁+I₁.

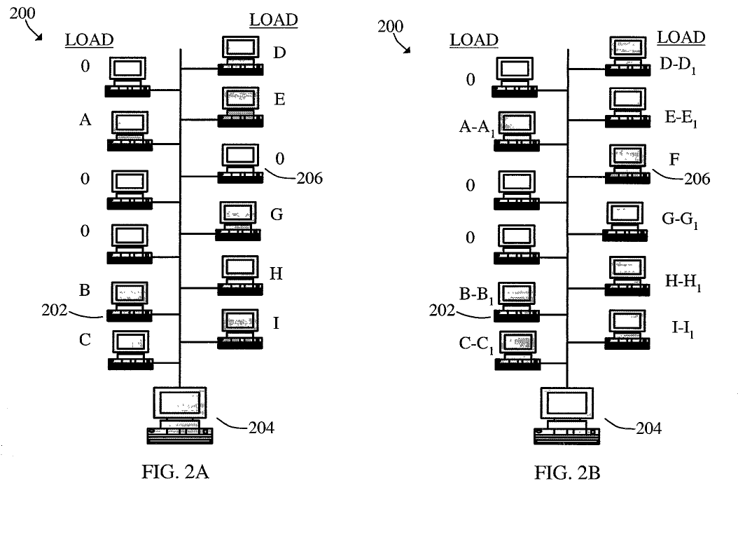

Just as the virtual supercomputer of the present invention reconfigures itself when a computer drops out, the virtual supercomputer of the present invention reconfigures itself whenever it detects the availability of a new computer on the network. FIGS. 2A and 2B are schematic diagrams showing how the virtual supercomputer of the present invention reconfigures itself when a new member computer joins the virtual supercomputer. In FIG. 2A, network 200 comprises a plurality of multipurpose computers in communication with one another. Some of the computers are members of a virtual supercomputer, as indicated by the shading in FIG. 2A. The processing load for each computer in network 200 associated with the virtual supercomputer is as shown. For example, member computer 202 has processing load B associated with computations assigned by master computer 204. In contrast, computer 206 has a processing load of zero because it is not a member of the virtual supercomputer. In FIG. 2B, computer 206 has just joined the virtual supercomputer of the present invention. When this occurs, master computer 204 redistributes the load among the member computers as shown in FIG. 2B.

The new load on each member computer may be reduced according to some percentage depending on the processing capabilities of the new member computer. For example the new member computer 206 may receive an initial load of F, which in turn represents an incremental decrease in the load assigned to each member computer, as shown in FIG. 2B. That is, F=A₁+B₁+C₁+D₁+E₁+G₁+I₁. The incremental decrease may be proportional to the processing capabilities of each member computer in the virtual supercomputer, or the incremental decrease could be determined according to some other algorithm for load distribution. For example, B₁, the incremental decreased load on member computer 202, may be given by:

$${B}_{1} = \frac{B}{T} \times F ,$$

where B is the load previously assigned to member computer 202, F is the load to be assigned to new member computer 206, and T is the total load assigned to member computers before assigning load F to member computer 116.

Regardless of the precise mechanism used to redistribute the load among remaining member computers, master computer 120 may take into account the following items when redistributing the load. Master computer 102 may ensure that all fractions of the load are accounted for. That is, although the incremental load for each remaining member computer may be expressed as a percentage or fraction of the load previously assigned to the dropped computer, computer 116, it may not be possible to divide the tasks in exact precentages because some tasks can only be reduced to a minimum defined quanta as discussed in more detail in the section on initial load balancing below. Moreover, master computer 102 may use the most recent processing statistics for each remaining member computer to recompute the distribution according to the current procesing capabilities of the computers.

The flow chart shown in FIG. 3 illustrates the steps used in one embodiment of the present invention to build and utilize a virtual supercomputer for solving a computationally intensive problem. As would be apparent to one of ordinary skill in the art, the steps presented below may be automated such that whenever the master computer is restarted, a virtual supercomputer is established and computations are assigned to member computers as necessary to solve a given problem. As shown in FIG. 3, the steps may be grouped into three phases: Startup Phase 300, Computations Phase 310 and Shutdown Phase 320. Each of these phases is described in more detail in the sections below.

1. Startup Phase

In step 301 the master computer is powered on and in step 302, PVM daemon software is started on the master computer. Master application software and slave application software are started in steps 303 and 304, respectively. At the completion of step 304, a virtual supercomputer having a size of one member computer has been established. Although such a virtual supercomputer could be used to solve a computationally intensive problem according to the present invention, a larger virtual supercomputer is preferable because of its increased processing capabilities.

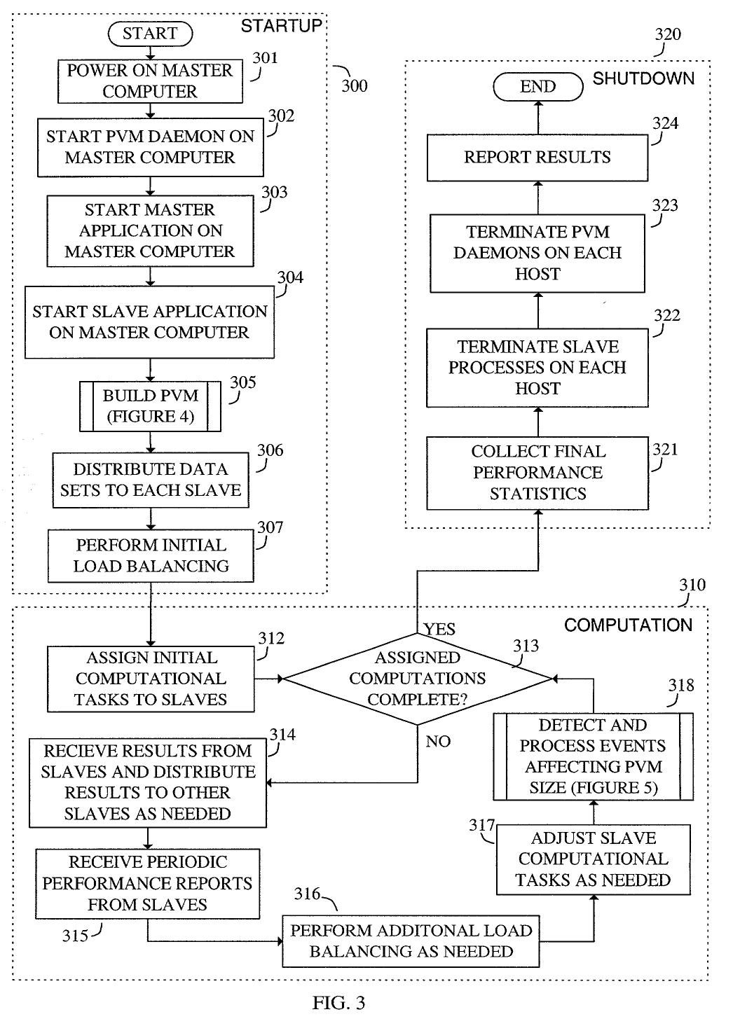

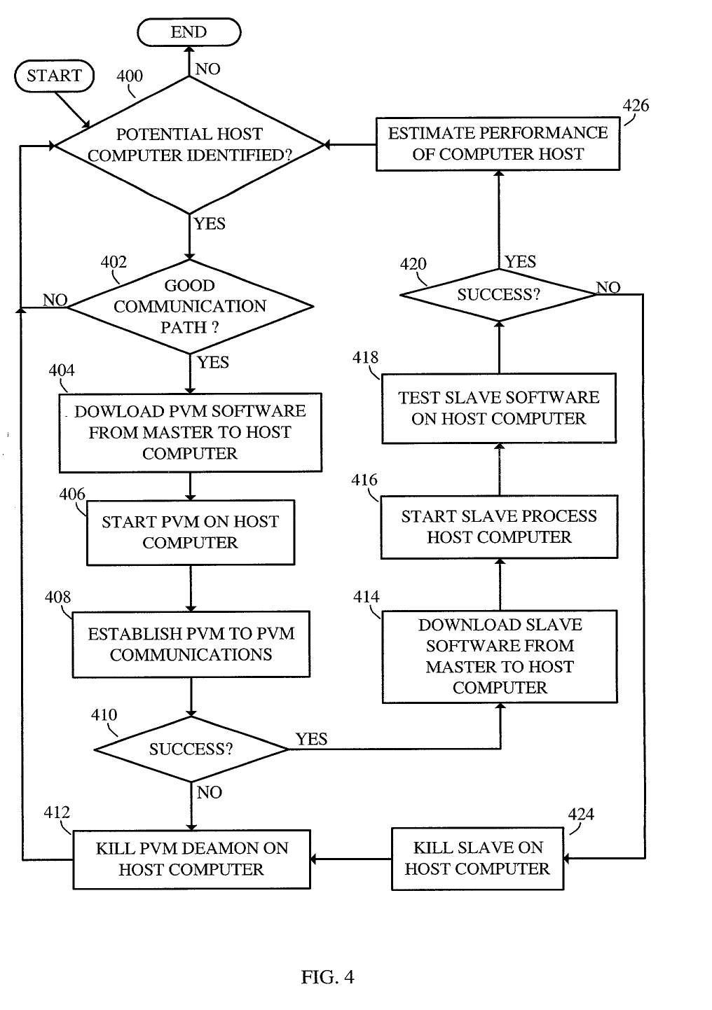

In step 305 the master computer (via the master application process) builds the virtual supercomputer according to steps such as shown in FIG. 4. Once the virtual supercomputer is built, the master computer distributes data sets to each slave computer. As used herein, the terms “slave computer”, “member computer” and “member of the virtual supercomputer” refer to any computer in the virtual supercomputer actively running the slave software previously described. For example, master computer 102 and multipurpose computer 120, shown in FIG. 1A, are both “slave computers.” In step 306 the master computer distributes whatever data sets and information are required for subsequent computation to each slave computer in the virtual supercomputer of the present invention. In one embodiment, the data sets may include data together with calculation instructions to be applied to the data. In this embodiment, the slave application implemented on the slave computers may be a very simple application designed to receive instructions and data from the master and to execute the instructions as directed. Alternatively, the slave application could be more complex comprising the computational instructions needed to solve the problem under consideration. In another alternative embodiment, the slave application may comprise a combination of computational instructions embedded in the software as well as the capability to receive additional computational instructions from the master computer.

In step 306 master computer prepares each slave to perform computations. This may include providing data for computations and any other information needed by the slave to perform any tasks that may be assigned to the slave or needed by the slave to perform any calculations required for performance testing and load balancing.

In step 307 master computer 102 performs an initial load balancing for the virtual supercomputer. In this step the master computer can use information received from each member computer to estimate the individual and collective processing capacity for computer and the virtual supercomputer as a whole. Using such information, the master computer can determine the appropriate load distribution for the virtual supercomputer of the present invention. Additionally, as noted above, the master computer is programmed to divide the computationally intensive problem into discrete task sets. Each task set is herein defined as the task quanta. Accordingly, the entire computationally intensive problem can be thought of as the sum of all task quantum. Because the task quanta are discrete task sets, the master computer can keep track of which slave computers have been assigned which quanta. Moreover, in later steps, the slave computers provide the results for each task quanta on an on-going basis, thereby allowing the master computer to update data sets and task quanta as needed to solve the computationally intensive problem.

2. Computational Phase

Each slave computer commences calculations as pre-programmed within the slave application, as directed by master computer 102, or according to a combination of pre-programmed computations and dynamic computational instructions received from the master computer as assigned in step 312. Tasks to be performed may be queued either on the master or on the slaves as appropriate In step 313, master computer 102 monitors the status of the computational efforts of the virtual supercomputer. If all of the assigned computational tasks have been completed master computer 102 moves on to step 321. Otherwise, in step 314 master computer 102 monitors the network for computational results transmitted by individual slave computers. As results are received in step 314, master computer 102 may distribute them to one or more of the other slave computers in the virtual supercomputer.

As discussed above, each slave computer in the virtual supercomputer of the present invention provides periodic performance reports to master computer 102 (step 315). The periodic performance reports may comprise results of special benchmark computations assigned to the slave computer or may comprise other performance metrics that can be used to indicate the load on the slave computer. Because the slave computers of the present invention comprise a plurality of multipurpose computer systems, it is important that the master computer monitor the performance and loading on the slave computers so that adjustments can be made in task assignments as necessary to provide maximum throughput for the virtual supercomputer's computations.

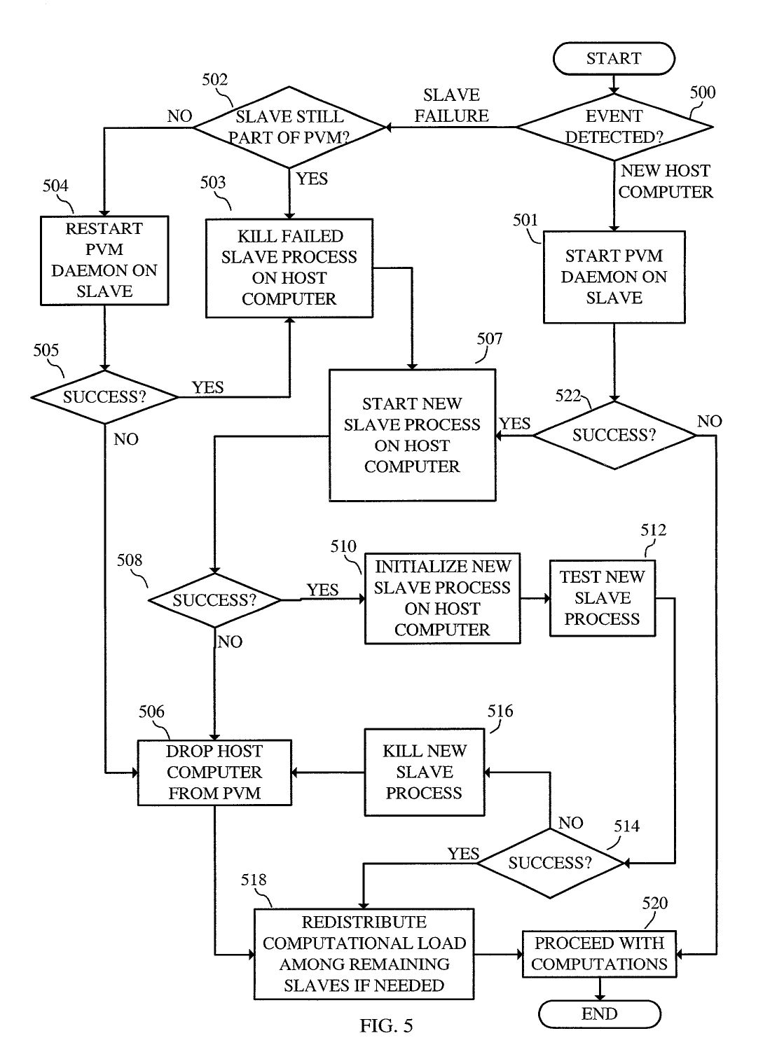

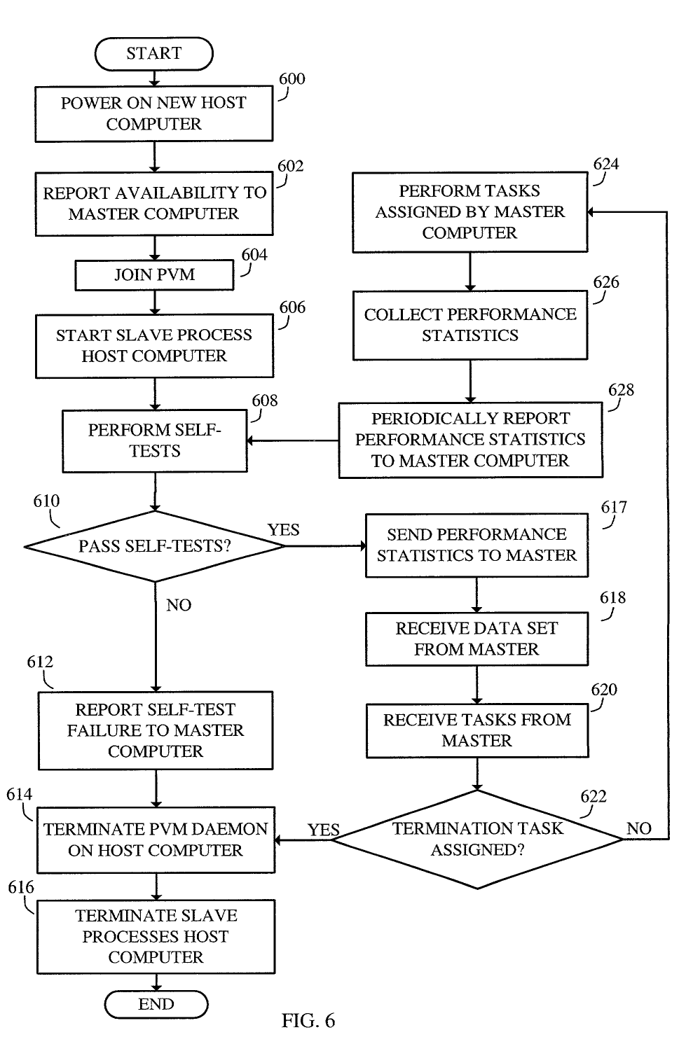

In step 316, master computer 102 uses the performance data received from the slave computers to determine how to best balance the load on the virtual supercomputer. In step 317, master computer 102 retrieves and reassigns uncompleted computational tasks from slave computers according to the load balancing scheme developed in step 316. In step 318, master computer 102 monitors the network to detect and process events that affect the size of the virtual supercomputer. Such events include the failure of a slave process on a slave computer or the failure of a slave computer itself, in which case, the virtual supercomputer may decrease in size. Similarly, the event may be the addition of new slave computers thereby increasing the size and computing capacity of the virtual supercomputer. In either case, master computer 102 may process the events as shown in FIG. 5.

3. Shutdown Phase

As described above, once all of the computational tasks for a given computationally intensive problem have been completed, the process moves on to Shutdown Phase 320. In step 321 master computer 102 collects final performance statistics from each slave computer. These performance statistics can be used, for example, to establish a baseline for subsequent virtual supercomputers built to solve other computationally intensive problems. Among other things, the statistics could be used to show the increased utilization of computer assets within an organization.

Finally, in steps 322-324, the virtual supercomputer of the present invention is torn down and general housekeeping procedures are invoked. That is, in step 322 the slave application on each slave computer is terminated and in step 323, the PVM daemon is terminated. In step 324, the results of the virtual supercomputer's computations are available for reporting to the user.

Building a PVM

As noted above, once the master computer comes online, i.e., the master computer has been powered on, the PVM daemon has been invoked and the master and slave applications have been started, the master computer attempts to increase the size of the virtual supercomputer in step 305. FIG. 4 shows a flow of steps that may be used in an embodiment of the present invention to build the virtual supercomputer. In step 400, master computer 102 determines if any potential host computers have been identified. This step may be carried out in several different ways, including for example, by polling known potential host computers to see if they are available. In another embodiment, each potential host computer periodically broadcasts its availability to the network, or directly to master computer 102. In yet another embodiment, some combination of polling by the master and announcing by the potential hosts can be used to identify potential host computers.

Once a potential host computer has been identified, master computer 102 determines whether or not the communications path between itself and the potential host is adequate for supporting the virtual supercomputer in step 402. This may be accomplished using standard network tools such as “ping” for a TCP/IP network, or using proprietary data communications tools for determining the network bandwidth or stability as needed. If the communications path is not good, master computer 102 returns to step 400 to see if any other potential hosts are identified. Otherwise, if the communications path is good, master computer 102 moves on to step 404 where PVM daemon software is downloaded from the master computer to the potential host computer. Step 404 (and/or step 414, described below) could be accomplished using a “push” method wherein the master computer sends the daemon to the potential host with instructions to start the daemon. Alternatively, steps 404 and/or 414 could be accomplished using a “pull” method wherein the potential host actively retrieves the software from the master. In either case, it is to be understood that the software may also be downloaded from some other computer system as long as the master and potential slave know where the software is located for download. Alternatively, each potential host computer could have a local copy of the software on a local storage device. This latter embodiment would not be desirable in most environments because of the added administration costs due to configuration management and software changes which would require updates on each system individually. However, there may be some cases where the software configuration of the PVM daemon and/or the slave application are sufficiently stable that local distribution may be desirable.

In step 406, the PVM daemon on the potential host computer is started and in step 408, PVM to PVM communications are established between the PVM daemon process on the master computer and the PVM daemon process on the potential host computer. In step 410, if the PVM to PVM communications could not be successfully established, the process moves on the step 412 where the PVM daemon is terminated on the potential host. Then, master computer 102 returns to step 400 to look for additional potential host computers. Otherwise, if the PVM to PVM communications is successfully established, the process moves on to step 414 where the slave application is downloaded to the potential computer.

In step 416 the slave application is started on the potential host computer and in step 418 the slave application is tested to ensure correct computations are made. The testing in step 418 may be accomplished, for example, by sending a computational instruction and a pre-determined data set to the slave. The slave then performs the required calculations and returns a result to the master computer. In step 420, the master computer then compares the reported result with the known correct result to determine whether or not the slave application on the potential host is working properly. If the slave is not working properly, the process moves on to step 424 and the slave application is terminated on the potential host computer. Next, the process continues cleanup procedures in step 412 and returns to step 400 to look for the next potential host to join the virtual supercomputer. If, in step 420, the slave application returns valid results, the “potential host” has become a “member” of the virtual supercomputer. The process moves on to step 426 where the performance or workload capacity for the new member computer is estimated. This estimation can be based on the speed of the test computations or on some other metric for gauging the expected performance for the computer. The estimated performance is used to perform the initial load balancing discussed in conjunction with step 307 in FIG. 3. Finally, the process returns to step 400 to see if any additional potential hosts can be identified. If not, the process of building the PVM has been completed, i.e., step 307 in FIG. 3, has been performed.

1. Dynamic Reconfiguration—Master Computer

As described above, the virtual supercomputer of the present invention dynamically reconfigures itself as slave computers become available for joining the virtual supercomputer or as slave computers leave the virtual supercomputer. Events affecting the size of the virtual supercomputer are detected in step 318 in FIG. 3. FIG. 5 provides a more detailed flow of steps that can be used to reconfigure the virtual supercomputer in response to such events. In step 500, when an event is detected, the process determines whether the event is a new computer host becoming available to join the virtual supercomputer, or is a failure of one of the existing slave systems. In the former case, the process moves on to step 501 and in the latter case, the process moves on to step 502. Events can be detected or indicated on master computer 102 using any suitable detection mechanism. For example, a slave failure may be indicated if master computer 102 sends a message to a particular slave computer but receives no response within some pre-determined interval of time. In another situation, master computer 102 may detect a slave failure if it does not receive periodic performance statistics or computational results within a pre-determined interval of time. Also, master computer 102 may detect a slave failure if a member computer provides erroneous results for a known set of baseline data. Similarly, detecting the availability of a potential host computer to join the virtual supercomputer can be accomplished in several ways. For example, the newly available potential computer may broadcast its availability to the network or provide direct notice to the master computer. Alternatively, the master computer could periodically poll the network for systems known to be potential members of the virtual supercomputer.

Looking first at the case of a failed slave system, the process moves on to step 502 where master computer 102 determines whether or not the host is reachable via PVM-to-PVM communications. If the host is reachable, i.e., slave computer is still part of the virtual supercomputer, the process moves on to step 503. Otherwise, if the PVM daemon is not functioning properly on the slave computer, the process moves on to step 504 and master computer 102 instructs the host computer to restart its PVM daemon. In step 505, if the PVM daemon can is successfully restarted on the host computer, the process moves on to step 503. If the daemon could not be restarted, the process moves on to 506 and master computer 102 drops the slave computer from the virtual supercomputer.

The steps presented in FIG. 5 are from the perspective of the master computer. That is, master computer 102 may still attempt to perform steps 504 and 505 even if the network communications path between the master computer and the slave computer has failed. Also, it is possible that the slave application and/or PVM daemon continue to run on the failed slave computer even after the master has dropped it from the virtual supercomputer. In this case, the slave application and/or PVM daemon can be programmed to terminate on the slave computer if they do not receive feedback from the master within a pre-determined interval of time.

If PVM-to-PVM communications are running between the two computers, master computer 102 sends a message to the failed host instructing it to terminate the failed slave application on the host in step 503, if it is still running on the machine. In step 507, master computer 102 instructs the failed slave computer to start (or restart) the slave application. In step 508, master computer 102 determines whether or not the slave application has been successfully started on the slave computer. If the slave application could not be started, the process moves on to step 506 where the failed host is dropped from the virtual supercomputer. As noted above, certain house keeping operations may be automatically or manually performed on the slave computer if it loses effective contact with the virtual supercomputer.

If the new slave application was successfully started on the host computer, the process moves on to step 510 where the slave application is initialized on the host computer. In step 512, the slave application is tested to ensure proper results are computed for a known problem or data set. In step 514 if the slave application returns erroneous results, the process moves on to step 516. In step 516, master computer 102 instructs the slave computer to terminate the slave process. After the slave process is terminated, master computer 102 removes the slave computer from the virtual supercomputer in step 506. As discussed above, step 506 may also comprise termination of the PVM daemon on the slave computer.

Back in step 514, if the slave application produces the expected results the process moves on the step 518. In step 518, master computer redistributes the load on the virtual supercomputer as needed to achieve maximum efficiency and utilization of available computing resources. As shown in FIG. 5, step 518 is performed whenever a slave drops out of the virtual supercomputer and whenever a slave joins the virtual supercomputer. In step 520 the process is complete and the virtual supercomputer continues solving the problem presented to it.

If the event detected in step 500 is the availability of a new host computer, many of the same steps as described above can be performed as shown in FIG. 5. First, in step 501 the new host is added to the virtual supercomputer. Again, this may comprise an instruction from master computer 102 directing the new host to download and start a PVM daemon. In step 522, if the new host cannot be joined into the virtual supercomputer, if, for example, PVM-to-PVM communications are not successfully established between the master computer and the new host, the process moves on to step 520. In step 520 the virtual supercomputer continues in its existing configuration. On the other hand, if PVM-to-PVM communications are successfully established, the process moves on to step 507 where the new host is instructed to start slave application as described above.

2. Dynamic Reconfiguration—Host Computer

FIG. 6 shows steps the that can be performed on a new host computer when the host becomes available to join the virtual supercomputer in one embodiment of the present invention. The steps in FIG. 6 are presented as they would be performed on the new host computer. Starting in step 600, the host computer is powered on or otherwise joins the computer network supporting the virtual supercomputer. In step 602, the new host computer reports its availability to join the virtual supercomputer. As described above, this step may be initiated by the new host computer or may be in response to a query from master computer 102.

In step 604 the new host computer joins the virtual supercomputer. As described above, this step may be performed by the new host computer after it downloads a PVM daemon application from the master computer or from some other location on the network. Alternatively, the new host computer may run the PVM daemon software from a copy stored locally on its hard disk. After the PVM daemon is running, PVM-to-PVM communications are established between the new host computer and the virtual supercomputer's master computer.

In step 606 the new host computer starts a slave application process so that it can participate in solving the problem presented. The slave application process may be downloaded from the master computer or from some other location on the network, or may be stored locally on the new host computer. In step 608 the new host computer performs a series of self-tests on the slave application. The self-tests may comprise computing results for a known data set and comparing the computed results to the known correct results. As shown in FIG. 6, in step 610 if the self-test is not successful the process moves on to step 612 where the failure is reported to the master computer. Next, in step 614 the PVM daemon on the new host computer is terminated. Finally, in step 616 the slave application process on the new host computer is terminated.

In step 610, if the self-test was successful, the process moves on to step 617 where the new host computer sends performance statistics to the master computer. The master computer uses these performance statistics to estimate the processing capabilities of the new host computer. In alternative embodiments, the new host computer may report processor speed and percent utilization, memory capacity and other such statistics that may affect its processing capacity. Alternatively, the master computer can base its estimates on past history for the particular new host computer or on other information such as the type or location of the computer, or the identity of the new host computer's primary user, if one has been identified.

In step 618 the new host computer receives one or more data sets from the master computer. As described above, the data sets may comprise data and/or computing instructions, depending on the complexity of the slave application implemented in the new host computer. In step 620 the new host computer receives one or more task quantum from the master computer, depending on the new host computer's estimated processing capabilities. In step 622, the new host computer determines whether or not the task quantum received includes an instruction to terminate processing. If so, the process moves on to step 614 to cleanup before ending processing. If there has been no termination task assigned, the new host computer performs the assigned tasks in step 624. In step 626, the new host computer collects performance statistics and in step 628 these statistics are periodically sent to the master computer for use in load balancing operations. The new host computer continues processing the tasks as assigned and performing periodical self-tests until a termination task is received or until the an error is detected causing the slave application to self-terminate.

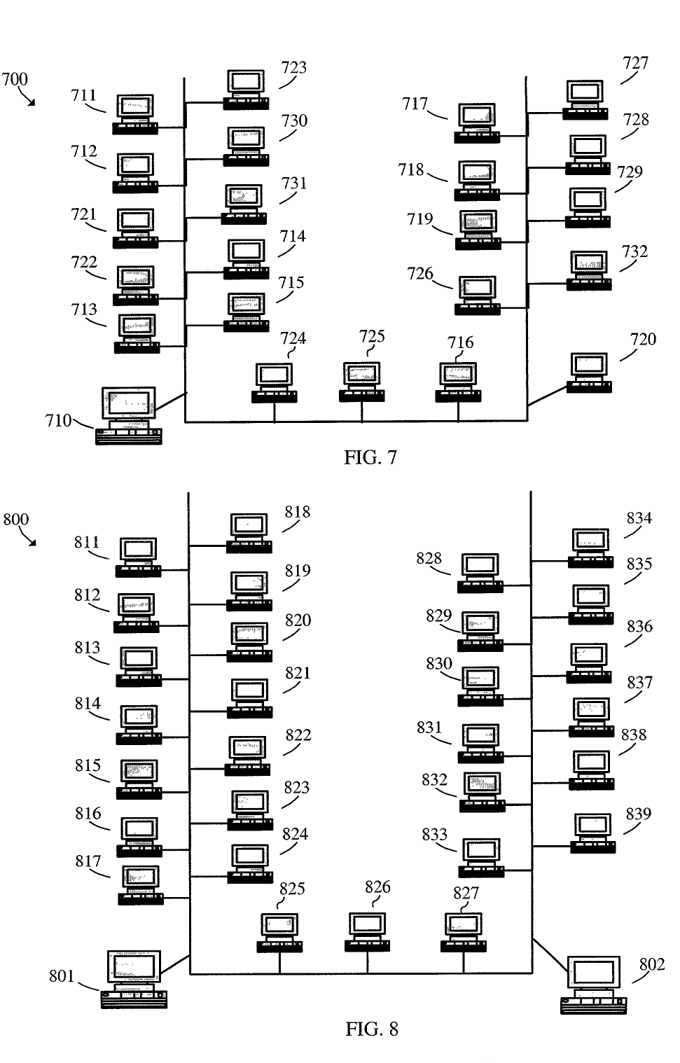

The architecture and steps described above can be used to build and operate a parallel virtual supercomputer comprising a single master computer and one or more slave computers. In the embodiments thus described, the master computer assigns all tasks and coordinates dissemination of all data among slave computers. In an alternative embodiment, one ore more slave computers can be configured to act as sub-master computers, as shown in FIG. 7.

Network 700 in FIG. 7 comprises a plurality of multipurpose computers in communication with one another. Master computer 710 is the master of the virtual supercomputer shown in FIG. 7. Additionally, multipurpose computers 720 and 730 act as sub-master computers. In this embodiment, master computer 710 still oversees the formation and operation of the virtual supercomputer as described above. For example, master computer 710 performs load balancing and assigns data sets and tasks to slave computers in the virtual supercomputer. Sub-master computers 720 and 730 can also assign data sets and tasks to other slave computers. This embodiment can be advantageously implemented to solve problems for which incremental or partial solutions to sub-problems are needed to solve the overall computationally intensive problem. For example, consider branch-and-bound optimization problems. The problem is divided into two subproblems. If no solution is found by examining each subproblem, each subproblem is in turn divided into two subproblems. In this manner, the original problem lies at the root of a binary tree. The tree grows and shrinks as each subproblem is investigated (or fathomed) to obtain a solution or is subdivided into two more sub-subproblems if no solution is found in the current subproblem. In this embodiment, a slave assigned a subproblem becomes a sub-master when it is necessary to split its subproblem in two by assigning the resulting subproblems to other slaves of the virtual supercomputer. In this manner, the work required to search the tree can be spread across the slaves in the virtual supercomputer.

In another alternative embodiment, a single network of multipurpose computers may be used to build more than one virtual supercomputer. In this embodiment, multiple master computers are each configured to solve one or more particular problems. FIG. 8 shows a schematic diagram of a network supporting multiple virtual supercomputers according to this embodiment of the present invention. Network 800 is a network comprising two master computers 801 and 802 and a plurality of multipurpose computers 811-839. Because each virtual supercomputer, by design, consumes maximum available computing resources on its member computers, a prioritized resource allocation system may be implemented. For example, a system administrator may assign a higher priority to master computer 801 than is assigned to master computer 802. The system administrator may further dictate that whenever master computer 801 is up and running it has complete priority over master computer 802. In this case, every available multipurpose computers will attempt to join master computer 801's virtual supercomputer. Only if master computer 801 is not available will the multipurpose computers join master computer 802's virtual supercomputer.

Alternatively, the system administrator could allocate a predefined percentage of available multipurpose computers to the virtual supercomputer of each master computer. That is, for example, master computer 801's virtual supercomputer may be entitled to 65% of the multipurpose computers available at any given time, while master computer 802's virtual supercomputer only gets the remaining 35% of the computers. As member computers drop out of the network or as potential member computers become available, the two master computers coordinate to ensure the system administrator's allocation scheme is satisfied. As known in the art, the communications between the two master computers could be accomplished via a network channel separate from PVM communications. Alternatively, modifications could be made to the PVM daemon to facilitate PVM-to-PVM communications between multiple parallel virtual machines.

Alternatively, each potential member computer on the network may be assigned to a primary master computer. In this embodiment, whenever the assigned primary master computer is up and running, the assigned multipurpose computer will first attempt to join that master's supercomputer. If the primary master is not processing any problems when the potential member computer becomes available, the multipurpose computer can attempt to join one of its secondary master computers to assist in solving a different problem.

In another embodiment of the present invention, multiple virtual supercomputers may coexist on a network wherein the virtual supercomputers share some or all of the same member computers. That is, in this embodiment, a single multipurpose computer may be a member of more than one virtual supercomputer. This embodiment could be implemented in situations wherein the problems being solved by the virtual supercomputer do not consume all of the available resources on member computers all of the time. That is, some problems such as the branch-and-bound optimization solver mentioned previously may involve intermittent periods of idle processor time while data is retrieved or results are being transferred among member computers. During this idle processing time, the member computer can work on problems assigned to it by its other master computer.

In another alternative embodiment, multiple virtual supercomputers can be implemented on the same network wherein the master computers of each virtual supercomputer can “negotiate” with other master computers on the network. In this embodiment, a virtual supercomputer may be established to solve a given problem within a pre-determined timeframe. Based on the computing resources it has available, the master computer may determine that its deadline cannot be met without additional resources. In this case, the master computer can request additional resources from other master computers on the network. The request may include information such as the requesting virtual supercomputer's priority, the number of additional processors required, the amount of time the processors will be used by the requester and any other information needed to determine whether or not the request should be satisfied by one of the virtual supercomputers on the network.

In another alternative embodiment, a central database of potential member computers is maintained on the network. Whenever a master computer boots up and starts building a new virtual supercomputer, the master consults the list and “checks out” a block of potential member computers. The master computer attempts to join each checked out member computer into its virtual supercomputer. If one of the member computers fails to properly join the virtual supercomputer, the master computer can report this information to the central database and check out a replacement computer. Similarly, when a new master computer boots up and starts building its own virtual supercomputer, it consults the central database to check out available member computers. Whenever a member computer drops out of its previously assigned virtual supercomputer, the central database is updated to reflect that computer's availability or its unavailability if the drop out was due to a failure. The central database can be periodically updated by polling the network for new computers available to join a virtual supercomputer. Alternatively, the central database can be updated whenever a change in a multipurpose workstation's status is detected.

An Example of a Specific Implementation of One Embodiment of the Present Invention

A specific implementation of one embodiment of the invention is described to illustrate how certain factors may be taken into consideration when configuring both the virtual supercomputer and master and slave applications for solving a particular computationally intensive problem. The computationally intensive problem to be solved in this example is known as the Multi-Indenture, Multi-Echelon Readiness-Based Sparing (MIMERBS) system for solving large, non-linear integer optimization problems that arise in determining the retail and wholesale sparing policies that support the aircraft operating from a deployed aircraft carrier. MIMERBS determines the minimum cost mix of spare parts that meets required levels of expected aircraft availability. The size (thousands of variables) and the non-linear relationship between spare parts and aircraft availability make this problem hard. MIMERBS is a non-linear integer optimization methodology developed to run across a virtual supercomputer of existing Windows NT computers networked together by an ordinary office LAN. A more detailed description of this specific embodiment can be found in Nickel, R. H., Mikolic-Torreira, I., and Tolle, J. W., 2000, Implementing a Large Non-Linear Integer Optimization on a Distributed Collection of Office Computers, in Proceedings, 2000 ASME International Mechanical Engineering Congress & Exposition, which is herein incorporated by reference in its entirety.

This example describes the configuration of the virtual supercomputer and how the MIMERBS problem was parallelized to work efficiently in view of the high communications costs of this particular embodiment of a virtual supercomputer. Additionally, this example describes how the MIMERBS software was made highly fault-tolerant and dynamically configurable to accommodate handling the loss of individual computers, automatic on-the-fly addition of new computers, and dynamic load-balancing. Experience with this specific embodiment has shows that performance of several gigaFLOPS is possible with just a few dozen ordinary computers on an office LAN.

Introduction to MIMERBS

As noted above, MIMERBS is used for solving large, non-linear integer optimization problems that arise in determining the mix of spare parts that an aircraft carrier should carry to keep its aircraft available to fly missions. Because MIMERBS is a faithful mathematical model of real-world sparing and repair processes, the model presents a computationally intensive problem. The computational demands are so great that MIMERBS requires the power of a supercomputer to generate optimal sparing policies in a reasonable amount of time. In lieu of an actual supercomputer system, a virtual supercomputer constructed out of a collection of ordinary office computers according to the present invention was used to do the MIMERBS computations in a timely manner

Establishing A Virtual Supercomputer for this Specific Implementation

As previously described, any suitable software for establishing a virtual supercomputer may be used by the present invention. In this specific implementation the Parallel Virtual Machine (PVM) software package developed by Oak Ridge National Laboratory was used to establish a virtual supercomputer. While PVM was originally designed to work in a UNIX environment, ports of PVM to a Windows environment are available. For this example, a new port of the software was implemented to overcome problems experienced with existing ports. Two primary problems with existing ports were: (1) that they rely on the global variable ERRNO to determine error states even though it is not set consistently by functions in the Windows API; and, (2) their conversion to using registry entries instead of environment variables is incomplete or inconsistent. The ported version of the software used in this example corrected both of these problems and resulted in a highly stable implementation. In this specific implementation the virtual supercomputer has been routinely up and running for weeks at a time, even when participating computers are repeatedly dropped and added, and a series of application runs are made on the virtual supercomputer.

In this specific implementation, computers using the Windows NT v. 4.0 with Service Pack 6A loaded were configured to participate in the virtual supercomputer as follows:

1. One computer is configured as a Windows NT server. This computer contains all PVM and application executables. The directories containing these executables are published as shared folders that can be accessed by other participating computers, i.e., member computers.

2. A separate shared directory is created on the server corresponding to each computer that may participate in the virtual supercomputer. These working directories are where each participating computer will store its corresponding PVM-related files.

3. The other participating Windows NT computers are configured with the standard PVM-related registry entries, except that the environment variable for the PVM root directory, PVM_ROOT, is set to the shared PVM root directory on the server and the environment variable for the temporary directory, PVM_TMP, is set to a shared directory on the server that corresponds to this particular machine.

4. No PVM or application software is installed on the other computers. All participating computers access the executables located on the server.

5. PVM computer-to-computer logins were supported via a licensed Windows NT implementation of a remote shell software, rsh, available from Fischer, M., 1999, RSHD Services for Microsoft WIN32, Web site, http://www.markus-fischer.de/getservice.htm. This software was installed on all the computers used in this specific implementation of the virtual supercomputer of the present invention. Additionally, each computer was configured with a dedicated and consistent usemame and password to support PVM computer-to-computer logins.

The participating computers are connected by an ordinary office LAN (a mixture of 10BaseT and 100BaseT). Both the LAN and most computers are used primarily for ordinary office work (email, file-sharing, web-access, word-processing, etc.). Participation in virtual computing is a secondary task. This configuration has several advantages. First, there is no need to distribute executables or synchronize versions across computers because all executables reside on a single computer. Second, elimination of orphaned PVM-related files (necessary for a computer to join the virtual supercomputer) is easy because they all reside on one computer. Third, debugging is simplified because error logs-which by default appear either in the corresponding PVM-related files or in files in the same directory as the PVM-related files-are all in located on the same computer that is initiating the computations and performing the debugging.

In this example, 45 computers were configured to participate in the virtual supercomputer, but many of these machines are not available during business hours due to other processing requirements resulting in numerous computers not being connected to the LAN. Accordingly, the virtual supercomputer in this example generally comprised 20 to 30 computers during business hours, with the number rising to 40 to 45 computers at night and during weekends (and then dropping again on weekday mornings). As would be apparent to one of ordinary skill in the art, a virtual supercomputer built on office computers connected by an ordinary LAN has communications delays that constrain the algorithms that can be efficiently implemented. Such constraints would be even more prominent if the virtual supercomputer is operated on a slower network such as for example, the Internet. In this example, using a combination of 10BaseT or 100BaseT Ethernet, the virtual supercomputer experienced point-to-point communications rates of 4.5 to 6.5 bytes/μsec, with a minimum communication time of about 15 msec for small messages.

Many common parallel processing techniques (e.g., decomposing matrix multiplication into concurrent inner products) could not be efficiently utilized given these communications delays. Accordingly, the virtual supercomputer in this specific implementation is not suitable for applications that require extensive and rapid communications between processors (e.g., finite-element solutions of systems of partial differential equations). Efficient use of this implementation of the virtual supercomputer was accomplished by decomposing the problem to be solved so that the duration of compute tasks assigned to processors was large relative to the communications time the tasks require. A wide variety of problems lend themselves to such decomposition, including, e.g., Monte-Carlo simulations, network problems, and divide-and-conquer algorithms.

Implementing The MIMERBS Algorithm

The MIMERBS optimization algorithm is an interior point algorithm. Our implementation of the interior point algorithm consists of repeated iterations of the following three steps: (1) a centering step that moves to the center of the feasible region, (2) an objective step that moves toward the continuous otpimal solution, and (3) a rounding step produces a candidate integer optimal solution. The first and third steps require intense numerical computations. We perform these two steps using an asynchronous parallel pattern search (APPS) algorithm. Because APPS is asynchronous and the messages required to support it are relatively short, it is very well suited for solving via a virtual supercomputer according to the present invention. However, significant changes to the original APPS algorithm were implemented to achieve reasonable performance in this example.

The original APPS algorithm, described in Hough, P. D., Kolda, T. G., and Torczon, V. J., 2000, Asynchronous Parallel Search for Nonlinear Optimization, SAND 2000-8213, Sandia National Laboratory, can be described as follows:

APPS Algorithm 1.

The goal is to minimize f(x) where x is contained in Rⁿ. Each processor is assigned a search direction \vec{d} and maintains a current best point x_{best}, a corresponding best value f_{best}=f(x_{best}) and a current step size Δ. Each processor performs the following steps:

1. Check for potentially better points reported by another processor; if a better point is received, move there. Specifically, consider each incoming triplet {xᵢₙ, fᵢₙ, Δᵢₙ} received from another processor. If fᵢₙ<f_{best} then update {x_{best}, f_{best}, Δ}←{x_{fin}, fᵢₙ, Δᵢₙ}.

2. Take a step of the current size in the assigned direction. Specifically, compute xₜᵣᵢₐₗ←x_{best}+\vec{d} and evaluate fₜᵣᵢₐₗ=f(xₜᵣᵢₐₗ).

3. If the trial point is better, move there; otherwise reduce the step size. Specifically, if fₜᵣᵢₐₗ<f_{best} then update {x_{best}, f_{best}}←{xₜᵣᵢₐₗ, fₜᵣᵢₐₗ} and broadcast the new minimum triplet {x_{best}, f_{best}, Δ} to all other processors. Otherwise Δ←½Δ.

4. If the step size isn't too small, repeat the process; otherwise report that the currently assigned search has been completed. Specifically, if Δ>Δₛₜₒₚ, goto Step 1; else report local completion at {x_{best}, f_{best}}.

5. Wait until either (a) all processors have locally completed at this point or (b) a better point is received from another processor. In case (a), halt and exit. In case (b), goto Step 1.

The set of all search directions must form a positive spanning set for Rⁿ. This requires at least n+1 direction vectors, although it is common to use 2n direction vectors in the form of the compass set {e₁ . . . , eₙ −e₁ . . . , −eₙ} where eⱼ is the jth unit vector.

The first problem with Algorithm 1 is that it implicitly assumes either that there are at least as many processors as search directions, or that many concurrent but independent search processes (each searching a single direction) run on each processor. Because the MIMERBS application involves thousands of variables (n>>1000) implementation of this APPS algorithm would require either thousands of processor or hundreds (even thousands) of concurrent processes on each processor. Neither option proved practical for the present implementation. Accordingly, Algorithm 1 was modified so that each processor searches a set of directions, as opposed to a single direction.

The second problem with Algorithm 1 was that it performed very inefficiently on the virtual supercomputer primarily because it propagates many “better” solutions that are not significant improvements on the solution. On small applications (under 100 variables or so), this would not to be a significant problem. But on applications with hundreds or thousands of variables, execution time and computing behavior can be dominated by the transmission and computational response to an overwhelming number of “better” solutions whose improvement was often indistinguishable from accumulated rounding error. To solve this problem, a more stringent criteria for declaring a solution to be “better” was implemented. Using the new criteria, a trial solution not only has to be better, it had to be significantly better before it is propagated to other processors. This resulted in the following algorithm:

APPS Algorithm 2.

The goal is to minimize f(x) where x is contained in Rⁿ. Each processor is assigned a set of search directions {\vec{d}₁, . . . ,\vec{d}ₘ} and maintains a current best point x_{best}, a corresponding best value f_{best}=f(x_{best}), a current step size Δ, and an index k representing the current direction \vec{d}ₖ. Each host performs the following steps:

1. Check for potentially better points reported by another host; if a better point is received, move there. Specifically, consider each incoming triplet {xᵢₙ, fᵢₙ, Δᵢₙ} received from another host. If fᵢₙ<f_{best}−ε(1+|f_{best}|) then update {x_{best}, f_{best}, Δ}←{xᵢₙ, fᵢₙ, Δᵢₙ}.

2. Determine the next direction to look in. Specifically, the index corresponding to the next direction is k←(k mod m)+1.

3. If all m directions have been searched without success, reduce the step size, setting Δ←½Δ. If Δ>Δₛₜₒₚ, report local completion at {x_{best}, f_{best}} and goto Step 7.

4. Take a step of the current size in the current direction. Specifically, compute xₜᵣᵢₐₗ←x_{best}+\vec{d}ₖ and evaluate fₜᵣₐᵢₗ=f(xₜᵣᵢₐₗ).

5. If the trial point is better, move there. Specifically, if fₜᵣₐᵢₗ<f_{best}−ε(1+|f_{best}|) then update {x_{best}, f_{best}}←{xₜᵣᵢₐₗ, fₜᵣᵢₐₗ} and broadcast the new minimum triplet {x_{best}, f_{best}, Δ} to all other hosts.

6. Goto Step 1 to repeat the process.

7. Wait until either (a) all hosts have locally completed at this point or (b) a better point is received from another processor. In case (a), halt and exit. In case (b), goto Step 1.

Algorithm 2 is used in two places in MIMERBS's interior point algorithm: in the centering step and in the rounding step. Its use in the centering step is straightforward. To use Algorithm 2 in the rounding step, a rounding technique, described in Nickel, R. H., Goodwyn, S. C., Nunn, W., Tolle, J. W., and Mikolic-Torreira, I., 1999, A Multi-Indenture, Multi-Echelon Readiness-Based-Sparing (MIMERBS) Model, Research Memorandum 99-19, Center for Naval Analyses, is used to obtain an integer solution from the result of the objective step for each iteration of the interior point algorithm. This integer solution is then used as the starting point for Algorithm 2, and Δᵢₙᵢₜᵢₐₗ and Δₛₜₒₚ are selected so that the algorithm always takes integer steps and thus remain on an integer lattice (Δᵢₙᵢₜᵢₐₗ=4 and Δₛₜₒₚ=1 work well). In all cases, the current example uses the compass set for direction vectors and the objective function is set to the appropriate combination of cost and penalty functions.

Implementation Architecture

In the present example, MIMERBS was implemented using a master-slave architecture. This approach provides a clear division of responsibility between components that are executing in parallel. It also allows a very clean programming model that has a simple slave focused almost exclusively on actually carrying out APPS Algorithm 2 and a master that orchestrates the overall execution of the algorithm. This section describes in more detail exactly what the master and slaves do and how they coordinate their operations. The slave is the simpler of the two; its fundamental job is to execute APPS Algorithm 2 when directed by the master using the set of search directions assigned by the master. Although this is its primary task, the slave must also be able to respond to various demands from the master. Specifically, slaves:

1. Load data and setup information provided by the master.

2. Accept search directions as assigned by the master (including changes while APPS is in progress).

3. Start APPS using the initial values and objective function specified by the master.

4. Report new “best” solutions to the master.

5. Receive new “best” solutions from the master.

6. Report local search completion to the master.

7. Terminate APPS at the direction of the master.

8. Report performance statistics to the master.

9. Report problems of any kind to the master.

The setup information sent to each slave includes all the data necessary to compute any version of the objective function at any point. The objective function is specified by passing appropriate parameters and selectors to the slaves when initiating APPS. In this specific example, slaves never communicate directly with each other. Slaves only report to, and receive updates from, the master. This greatly simplifies slaves because they do not need to keep track of other slaves-in fact, slaves are not even aware that other slaves exist. As previously described, however, alternative embodiments of the present invention may include communications between and among slave computers. In the present specific embodiment, it is up to the master to broadcast solutions received from one slave to all other slaves. The master is more complex than the slave. It is responsible for performing data input and output, for directing the overall execution of the interior point algorithm, and for managing the slaves. To do this, the master performs the following functions:

1. Reads the input data.

2. Creates slaves on all hosts in the virtual supercomputer.

3. Sets up the optimization.

4. Propagates data and setup information to the slaves.

5. Carries out the iterations of the interior point algorithm:

(a) centering step: initiate and manage APPS by the slaves;

(b) objective step: performed entirely by master; and

(c) rounding step: the master rounds the continuous solution to get an initial integer solution, and then uses that solution to initiate and manage an integer search using APPS by the slaves.

6. Shuts down the slaves.

7. Generates appropriate reports and other output data.

From an implementation point of view, the most complex task the master does in this embodiment is to “initiate and manage APPS by the slaves.” This task is central to the parallel implementation and consists of the following subtasks: 1. start APPS by sending initial values and appropriate choice of objective function to all slaves; 2. receive “best” solution reports from individual slaves and rebroadcast them to all slaves; 3. track each slave's search status; 4. collect performance statistics provided by the slaves and adjust load allocations as needed; 5. terminate the search when all slaves have completed; and 6. deal with problems in the slave and changes in the virtual supercomputer. As noted previously, the master rebroadcasts received solutions to all other slaves. Although this may appear to be inefficient, it actually allows the present implementation to significantly speed up the convergence of APPS. This is accomplished by processing incoming solution reports in large blocks and re-broadcasting the best solution in the block instead of individually re-broadcasting every incoming solution. Because incoming solutions accumulate in a message queue while the master performs housekeeping chores, the master can process a large block of incoming solution reports without incurring any wait states. The net result is a reduction in network traffic due to re-broadcasts by about two orders of magnitude, without any significant degradation in how quickly slaves receive solution updates. This modification reduces the number of function evaluations needed for APPS to converge by 15 to 30 percent. Passing all communications through the master also gives an efficient means of dealing with the well-known asynchronous stopping problem, which arises when local slave termination is not a permanent state. That is, even after a slave has completed its search locally, it may restart if it receives an update containing a better solution than the one at which the slave stopped. Simply polling the slaves' status to see if all slaves are stopped is not sufficient because an update message may be in transit while the slaves are polled. Because all updates are broadcast through the master in the present implementation, all outgoing update messages can be tracked. Furthermore, slaves acknowledge every update message (they do so in blocks sent at local search termination to minimize the communications burden). This provides sufficient information to implement a reliable stopping rule: the master declares the search finished when all slaves have completed locally and all slaves have acknowledged all updates.

Fault Tolerance and Robustness

The virtual supercomputer implemented in this specific example is highly fault tolerant and allows individual hosts making up the virtual supercomputer to drop out (either due to failures or because their owners reboot them). Although the PVM software used to establish the virtual supercomputer allows the underlying set of host computers to change over time, it is up to the application running on the virtual supercomputer, in this case MIMERBS, to make sure that computations will proceed correctly when such changes occur. There are two issues related to robustness. The first is dynamically incorporating PVM-capable processors whenever they come on line. The second is dynamic load balancing in response to changing loads on processors.

The MIMERBS application implemented in this example has been designed to be extremely robust in its handling of faults that may occur during operations. The fundamental fault that MIMERBS must deal with is the loss of a slave. A slave can be lost for a variety of reasons: the processor that slave is running on has left the virtual supercomputer (e.g., rebooted or shutdown), the slave program itself has failed (e.g., runtime error or resource exhaustion), the PVM daemon on that processor has had a fatal runtime error, or the communications path to that slave has been broken. In this example, fault tolerance depends upon two functions performed by the master application: determining that a slave is “lost” and reacting to that situation.

The master determines that a slave is lost in several ways. First, PVM's pvm notify service may be used to receive notification (via PVM message) that a slave process has terminated or that a processor has left the virtual machine. This detects slaves that abort for any reason; processors that crash, reboot, or shutdown; remote PVM daemons that fail; and communications paths that break. Second, if a slave reports any runtime errors or potential problems (e.g., low memory or inconsistent internal state) to the master, the master will terminate the slave and treat it as lost. Finally, if the master doesn't receive any messages from a slave for too long, it will declare the slave lost and treat it as such (this detects communications paths that break and slaves that “hang”). The master reacts to the loss of a slave essentially by reassigning the workload of that slave to other slaves. To do this, the master keeps track of which search directions are currently assigned to each slave. When a slave is lost, the master first checks whether the processor on which that slave was running is still part of the virtual supercomputer. If so, the master attempts to start a new slave on that processor. If that succeeds, the old slave's search directions are reassigned to the new slave on that processor. If the lost slave's processor is no longer part of the virtual supercomputer or if the master cannot start a new slave on it, the master instead redistributes the lost slave's directions to the remaining slaves. This ensures that all directions are maintained in the active search set and allows APPS to proceed without interruption even when slaves are lost. The net result is that MIMERBS is not affected by faults of any slaves, of any remote PVM daemons, or of any remote processors. In this specific implementation, only three types of faults will cause MIMERBS to fail:

1. loss of the master processor;

2. fatal runtime errors in the PVM daemon running on the master computer; or

3. fatal runtime errors in the MIMERBS master program.

In each of these three cases a manual restart will resume computations from the last completed iteration of the interior point algorithm. The first two failure modes are an unavoidable consequence of using PVM: the virtual supercomputer will collapse if the processor that initiated the formation of the virtual supercomputer fails or if the PVM daemon running on that processor (the “master” PVM daemon) has a runtime error. Using a different software application to establish the virtual supercomputer can prevent this situation if an even more robust virtual supercomputer is desired. The third failure mode, fatal runtime errors in the MIMERBS master program, could be avoided by taking the approach (Hough et al., 2000) used in their implementation of APPS Algorithm 1. In that implementation there is no master computer: every slave is capable of functioning as “master” if and when required. Alternatively, the risk of fatal failure on the master computer can be reduced by initiating the formation of the virtual supercomputer and running the master program from the same processor. Moreover, if this processor is a dedicated computer that is isolated from other users and has an uninterruptible power supply, the risk can be further minimized.

Adding Hosts Dynamically

As previously noted, although PVM allows a processor to join the virtual supercomputer at any time, it is up to the master application, in this case MIMERBS, to initiate computations on that new processor. The MIMERBS master program uses PVM's pvm notify service to receive notification (via PVM message) whenever a new processor is added to the virtual supercomputer. The master responds to this notification by:

1. starting a slave on the new host;

2. sending all the necessary setup data to that slave;

3. conducting a computation test to verify that the new slave/host combination performs satisfactorily (if the new slave/host does not perform satisfactorily, the slave is terminated and the host dropped from the virtual supercomputer);

4. redistributing search direction assignments so that the new slave has its corresponding share; and

5. if an APPS search is in progress, also initiate APPS on the new slave by passing the appropriate parameters and the current best solution.

The master keeps track of what setup data is needed by maintaining an ordered list of references to all messages broadcast to slaves as part of the normal MIMERBS startup process. When a new slave is started, the master simply resends the contents of the list in a first-in, first-out order.

The above only addresses what happens once a new processor has actually joined the virtual supercomputer. The problem remains of detecting that a potential processor has come online and actually adding it to the virtual supercomputer. This feature is needed to automatically exploit the capabilities of whatever computers may become available in the course of a run. PVM does not provide this service directly, so the present implementation included a routine on the master computer that periodically checks to see if PVM-configured computers have come online and then adds any it finds to the virtual supercomputer.

Load Balancing

In addition to hosts joining and leaving the virtual supercomputer, the master application must adapt to ever changing computational loads on the processors that make up the virtual supercomputer. Because the present example uses ordinary office computers that are being used concurrently for daily operations, processor loading can change dramatically depending on what the user is doing. MIMERBS needs to respond to this change in load to ensure efficient computation.

Because APPS is asynchronous, the definition of a balanced load is not self-evident. Loosely speaking all search directions should be searched “equally rapidly.” Accordingly, in the present example, load balance is determined by the number of directions assigned to each processor. For example, if there are two processors in the virtual supercomputer, one twice as fast as the other, the faster processor is assigned twice as many directions as the slower one. In this example, a balanced load is established when, for all processors i, Nᵢ/Rᵢ=constant where Nᵢ is the number of assigned search directions on the ith processor and Rᵢ is the rate at which the objective function is evaluated on the ith processor.

To support dynamic load balancing, all slaves record performance data and regularly send it to the master. The master uses this data to detect changes in function evaluation rate and adjusts the load distribution whenever it becomes too unbalanced. The load is also rebalanced whenever a slave is lost or added. The actual rebalancing is accomplished by shifting assigned search directions from one slave to another.

In addition to performing dynamic load balancing, the present specific implementation also uses the Window NT scheduling scheme to regulate the relative priority of slave tasks so that slave tasks yield to user tasks, especially foreground user tasks. Specifically, slaves run as background processes with Process Priority Class set to NORMAL_PRIORITY_CLASS and Thread Priority Level set to THREAD_PRIORITY_BELOW_NORMAL. This ensures that desktop computers participating in the virtual supercomputer are highly responsive to their users. This is an important part of making the virtual supercomputer nearly invisible to ordinary users. As would be apparent to one of ordinary skill in the art, similar process prioritization schemes can be implemented on computers using different operating systems, including for example, UNIX, Linux, and the like.

Other Alternative Embodiments

The present invention also relates to applications and uses for the system and method of the present invention. In the currently preferred embodiment, the present invention can be used behind the firewall of an organization that has a number of under-utilized personal computers or workstations. Since many office environments use computers with powerful processors for tasks such as word processing and e-mail, there is ordinarily a substantial amount of under-utilized computer capacity in most medium and large sized offices. Thus, using the present invention, it is possible to take advantage of this under-utilized capacity to create a virtual supercomputer at a cost that makes the supercomputing capacity affordable. With the availability of low-cost supercomputing, a wide variety of applications that heretofore had not been practical to solve become solvable. Applications of the present invention include:

General Applications

Financial Applications.

Smaller financial institutions may desire to optimize loan or stock portfolios using the tools of modern portfolio theory. These tools often require the power of a supercomputer. The virtual supercomputer of the present invention would provide an option for acquiring this capability without making the financial commitment that a supercomputer would require.

Stock and Inventory Optimizations.

Determining optimal stock levels on a by-item, by-store basis, together with the corresponding trans-shipment plan (what to move to where) on a daily basis is a key competitive advantage of large distributors such as Wal-Mart. Up to now, solving such a large problem quickly enough to make daily updates possible has required dedicated high-end computer hardware. This problem can be solved by our virtual supercomputer on existing networks of office computers, allowing many smaller companies to take advantage of these techniques without any additional investment in computer hardware.

Branch-And-Bound Problems.

Optimization problems that use a branch-and-bound approach, e.g., integer programming problems, to find an optimal solution could be structured to use the virtual supercomputer.

Simulation.

Large-scale simulations could be run on the virtual supercomputer. With n computers in the virtual supercomputer, total run time could be reduced by a factor of n.

Routing and Scheduling.

Network optimization problems such as vehicle routing and scheduling could be subdivided and solved on the virtual supercomputer.

Database Analyses.

Database searching or mining could be done across a network of workstations using the virtual supercomputer. Each workstation could be assigned a portion of the database to search or analyze.

Image Analyses.

Suppose you need to find a tank (or other target), and you want to automatically search existing imagery. This takes much too long for a single personal computer, but it can be easily distributed across a network of computers.

Military Applications

Sonar Predictions.

In shallow water, you need to make 360-degree sonar predictions. These are generally done on one radial at a time. On an ordinary personal computer each radial takes about 15 seconds, so doing a full 360 degree analysis takes 90 minutes. The same computation running on a virtual supercomputer, comprising, e.g., 50 personal computers can be accomplished in about 2 minutes. Moreover, the individual results from the computers can be used to more readily formulate the sonar picture because each node can communicate with the other to share results.

Mission Planning.

Military mission planning systems, e.g., Tactical Aircraft Mission Planning System (TAMPS), are software tools used to plan air strikes and other operations. However most mission planning systems do not provide estimates of mission success or attrition because such estimates require extensive Monte Carlo modeling that is too time consuming (several hours) on the computer systems available at an operational level. As noted above, such simulation exercises can be easily accommodated on the cluster supercomputer of the present invention using computer systems readily available to the mission planners.

Finally, although the system is described in the currently preferred context of a secure (behind the firewall) office environment, the invention can be used with computers connected over the Internet or other such public network. In one embodiment, a process on the master computer for the cluster supercomputer logs into the slave computers to initiate the computing tasks on the slaves. Accordingly, a secure environment is preferable solely to alleviate concerns related to outside entities from logging into the computers in the network. A cluster supercomputer according to the present invention may operate on unsecured networks provided the cluster members are configured to allow access to the master computer. Also, from a practical standpoint, cluster supercomputers over the Internet would need higher speed connections between the linked computers to maximize the present invention's capabilities to share data between the nodes on a near real-time basis for use in subsequent calculations.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A method for solving a computationally intensive problem using a plurality of multipurpose computer workstations, said method comprising the steps of:
(a) building a virtual supercomputer comprising a master computer and at least one slave computer, wherein the at least one slave computer is selected from the plurality of multipurpose computer workstations;
(b) starting a master application on the master computer;
(c) starting a slave application on the at least one slave computer;
(d) dividing the computationally intensive problem into a plurality of task quantum;
(e) assigning to the at least one slave computer at least one task quanta selected from the plurality of task quantum;
(f) completing on the at least one slave computer the at least one task quanta;
(g) receiving on the master computer a result provided by the at least one slave computer; and
(h) repeating steps (e) through (g) until the computationally intensive task is solved.

2. The method of claim 1, wherein the master computer and the at least one slave computer are the same computer.

3. The method of claim 1, further comprising the step of balancing a load on the virtual supercomputer.

4. The method of claim 1, further comprising the steps of:
(a) detecting an event affecting a size of the virtual supercomputer; and
(b) balancing a load on the virtual supercomputer in response to the event.

5. The method of claim 4, wherein the event comprises an availability of a second slave computer selected from the plurality of computer workstations.

6. The method of claim 5, further comprising the step adding the second slave computer to the virtual supercomputer, and wherein the step of balancing a load comprises the steps of:
(a) retrieving the at least one task quanta assigned to the at least one slave computer;
(b) determining a processing capability for the at least one slave computer and the second slave computer; and
(c) distributing task quantum to the at least one slave computer and the second slave computer according to the determined processing capability.

7. The method of claim 4, wherein the event comprises a failure of the slave application on the at least one slave computer.

8. The method of claim 7, further comprising the steps of:
(a) restarting the slave application on the at least one slave computer; and
(b) testing the restarted slave application on the at least one slave computer.

9. The method of claim 4, wherein the event comprises a loss of communications between the master computer and the at least one slave computer.

10. The method of claim 9, further comprising the steps of:
(a) removing the at least one slave computer from the virtual supercomputer;
(b) determining which task quantum selected from the plurality of task quantum have not been completed;
(c) determining a processing capability for any remaining slave computers in the virtual supercomputer; and
(d) distributing at least one uncompleted task quantum to the remaining slave computers according to the determined processing capability.

11. The method of claim 1, further comprising the steps of:
(a) determining a processing capability for the at least one slave computer; and
(b) distributing the plurality of task quantum to the at least one slave computer according to the determined processing capability.

12. The method of claim 1, further comprising the step of collecting on the master computer a plurality of final performance statistics from the at least one slave computer.

13. The method of claim 1, further comprising the step of tearing down the virtual supercomputer.

14. The method of claim 13, wherein the step of tearing down the virtual supercomputer comprises the steps of:
(a) terminating the slave application on the at least one slave computer;
(b) terminating the master application on the master computer; and
(c) terminating the virtual supercomputer daemon application on the at least one slave computer and on the master computer.

15. The method of claim 1, further comprising the step of providing a result to the computationally intensive problem.

16. The method of claim 1, wherein the step of building a virtual supercomputer comprises the steps of:
(a) starting a first virtual supercomputer daemon application on the master computer;
(b) identifying a potential slave computer selected from the plurality of multipurpose workstations;
(c) downloading a second virtual supercomputer daemon application from the master computer to the potential slave computer;
(d) starting the second virtual supercomputer daemon application on the potential slave computer; and
(e) establishing a communications session between the first virtual supercomputer daemon and the second virtual supercomputer daemon.

17. The method of claim 15, further comprising the steps of:
(a) downloading a slave application from the master computer to the potential slave computer;
(b) starting the slave application on the potential slave computer;
(c) testing the slave application on the potential slave computer; and
(d) making the potential slave computer the at least one slave computer in the virtual supercomputer if the testing of the slave application is successful.

18. The method of claim 16, further comprising the step determining a performance capability of the at least one slave computer.

19. The method of claim 16, further comprising the step of repeating steps 16(b) through 16(e) until there are no more potential slave computers available among the plurality of multipurpose workstations.

20. The method of claim 19, further comprising the steps of:
(a) downloading a slave application from the master computer to the potential slave computer;
(b) starting the slave application on the potential slave computer;
(c) testing the slave application on the potential slave computer;
(d) making the potential slave computer the at least one slave computer in the virtual supercomputer if the testing of the slave application is successful;
(e) calculating a performance capability of the at least one slave computer; and
(f) repeating steps (a) through (e) until there are no more potential slave computers available among the plurality of multipurpose workstations.

21. The method of claim 1, wherein the computationally intensive problem comprises optimization of a financial portfolio.

22. The method of claim 1, wherein the computationally intensive problem comprises optimization of supply chain logistics.

23. The method of claim 22, further comprises determining optimal stock levels on a by-item, by-store basis, together with a corresponding trans-shipment plan on a daily basis.

24. The method of claim 1, wherein the computationally intensive problem is used in conjunction with a branch-and-bound approach to optimization.

25. The method of claim 1, wherein the computationally intensive problem is used in connection with large-scale simulations to reduce total run time.

26. The method of claim 1, wherein the computationally intensive problem comprises a network optimization problem.

27. The method of claim 26, wherein the network optimization problem comprises a vehicle routing and scheduling system.

28. The method of claim 1, wherein the computationally intensive problem comprises database searching across a network of workstations.

29. The method of claim 1, wherein the computationally intensive problem comprises database mining across a network of workstations.

30. The method of claim 1, wherein the computationally intensive problem comprises an image analysis program.

31. A method of building a virtual supercomputer comprising a master computer and at least one slave computer selected from a plurality of multipurpose workstations, said method comprising the steps of:
(a) starting a first virtual supercomputer daemon on the master computer;
(b) identifying a potential slave computer selected from the plurality of multipurpose workstations;
(c) starting a second virtual supercomputer daemon on the potential slave computer;
(d) establishing a communications session between the first virtual supercomputer daemon and the second virtual supercomputer daemon;
(e) starting the slave application on the potential slave computer;
(f) testing the slave application on the potential slave computer; and
(g) making the potential slave computer the at least one slave computer in the virtual supercomputer if the testing of the slave application is successful.

32. The method of claim 31, further comprising the step of calculating a performance capability of the at least one slave computer.

33. The method of claim 31, further comprising the step of repeating steps 31(b) through 31(g) until there are no more potential slave computers available among the plurality of multipurpose workstations.

34. The method of claim 31, further comprising the step of downloading a slave virtual supercomputer software from the master computer to the potential slave computer.

35. The method of claim 31, further comprising the step of downloading a slave application from the master computer to the potential slave computer.

36. A method for dynamically reconfiguring a virtual supercomputer while the virtual supercomputer is solving a computationally intensive problem, said method comprising the steps of:
(a) detecting an event affecting a size of the virtual supercomputer;
(b) reassigning a task quantum from a failed slave computer to at least one slave computer in the virtual supercomputer if the event is a slave failure event; and
(c) retrieving a task quantum from at least one slave computer in the virtual supercomputer and assigning the retrieved task quantum to a new slave computer if the event is a newly available slave event.

37. The method of claim 36, further comprising the steps of:
(a) terminating a slave application on the failed slave computer if the event is a slave failure event; and
(b) restarting the slave application on the failed slave computer if the event is a slave failure event, wherein steps 37(a) and 37(b) are performed before step 36(b) is performed.

38. The method of claim 37, further comprising the steps of:
(a) initializing the restarted slave application if the event is a slave failure event;
(b) testing the restarted slave application if the event is a slave failure event; and
(c) terminating the restarted slave application if the testing step is not successful, wherein steps 38(a) through 38(c) are performed before step 36(b) is performed.

39. The method of claim 38, further comprising the step of removing the failed slave computer from the virtual supercomputer if the testing step is not successful.

40. The method of claim 36, wherein the step of adding an additional slave computer to the virtual supercomputer if a workstation selected from the plurality of multipurpose workstations becomes newly available comprises the steps of:
(a) starting a virtual supercomputer daemon on the available workstation; and
(b) starting a slave application the newly available workstation.

41. The method of claim 40, further comprising the steps of:
(a) initializing the slave application on the newly available workstation; and
(b) testing the slave application on the newly available workstation.

42. A method for solving a computationally intensive problem using a plurality of multipurpose computer workstations, said method comprising the steps of:
(a) building a virtual supercomputer comprising a master computer and at least one slave computer, wherein the slave computer is selected from the plurality of multipurpose computer workstations;
(b) distributing a plurality of data sets to the at least one slave computer;
(c) balancing an initial load distribution on the virtual supercomputer;
(d) assigning initial computational tasks to the at least one slave computer;
(e) initiating computations on the at least one slave computer;
(f) receiving a first set of results from the at least one slave computer;
(g) adding an additional slave computer to the virtual supercomputer if a workstation selected from the plurality of multipurpose workstations becomes available;
(h) removing a slave computer from the virtual supercomputer if the slave computer becomes unavailable; and
(i) distributing the first set of results and additional data sets to the at least one slave computer until the computationally intensive problem has been solved.

43. The method of claim 42, further comprising the steps of:
(a) collecting a plurality of final performance statistics from each slave computer; and
(b) tearing down the virtual supercomputer.

44. A method for incorporating a new member computer into a virtual supercomputer solving a computationally intensive problem, said method comprising the steps of:
(a) sending a first messages from the new member computer to a master computer in the virtual supercomputer, said first message comprising an availability status for the new member computer;
(b) starting a virtual supercomputer daemon on the new member computer;
(c) starting a slave application on the new member computer;
(d) performing a self-test of the slave application on the new computer;
(e) sending a second message from the new member computer to the master computer, said second message comprising a performance statistic report;
(f) receiving a data set on the new member computer;
(g) receiving a task on the new member computer, said task comprising computational instructions for solving a portion of the computationally intensive problem; and
(h) completing the task on the new member computer.

45. The method of claim 44, further comprising the steps of:
(a) sending a third message from the new member computer to the master computer, said third message comprising a failure report if the self-test is not successful;
(b) terminating the virtual supercomputer daemon on the new member computer if the self-test is not successful; and
(c) terminating the slave application on the new member computer, if the self-test is not successful.

46. The method of claim 44, further comprising the steps of:
(a) collecting a plurality of performance statistics on the new member computer; and
(b) sending a third message from the new member computer to the master computer, said third message comprising the plurality of performance statistics.

47. A method for dynamically adding a new member computer to a virtual supercomputer while the virtual supercomputer is solving a computationally intensive problem, said method comprising the steps of:
(a) detecting the availability of the new member computer;
(b) providing a virtual supercomputer daemon to the new member computer;
(c) instructing the new member computer to start the virtual supercomputer daemon;
(d) providing a slave application to the new member computer;
(e) instructing the new member computer to start the slave application;
(f) redistributing a computational load on the virtual supercomputer; and
(g) performing computational tasks on the virtual supercomputer.

48. The method of claim 47 further comprising the steps of:
(a) providing an initial data set to the new member computer; and
(b) instructing the new member computer to perform a self-test using the initial data set.

49. The method of claim 48 further comprising the steps of:
(a) receiving a self-test result from the new member computer;
(b) instructing the new member computer to terminate the slave application if the self-test is not successful; and
(c) removing the new member computer from the virtual supercomputer if the self-test is not successful.

50. The method of claim 47, wherein the step of redistributing a computational load on the virtual supercomputer comprises the steps of:
(a) retrieving a plurality of task quantum from each member computer in the virtual supercomputer;
(b) determining a computational capability for each member computer in the virtual supercomputer; and
(c) assigning a subset of the plurality of task quantum to each member computer in the virtual supercomputer.

51. A method for dynamically processing a slave application failure on a member computer in a virtual supercomputer while the virtual supercomputer is solving a computationally intensive problem, said method comprising the steps of:
(a) detecting the slave application failure;
(b) instructing the member computer to restart the slave application;
(c) providing an initial data set to the member computer;
(d) instructing the member computer to perform a self-test using the initial data set;
(e) instructing the member computer to continue performing computational tasks for a previously assigned task quanta.

52. The method of claim 51 further comprising the steps of:
(a) receiving a self-test result from the member computer;
(b) instructing the member computer to terminate the slave application if the self-test is not successful;
(c) redistributing a computational load on the virtual supercomputer; and
(d) removing the member computer from the virtual supercomputer if the self-test is not successful.

53. The method of claim 52, wherein the step of redistributing a computational load on the virtual supercomputer comprises the steps of:
(a) determining which of a plurality of task quantum was previously assigned to the member computer;
(b) determining a computational capability for each member computer in the virtual supercomputer; and
(c) assigning a subset of the plurality of task quantum to each member computer in the virtual supercomputer.

54. A method for dynamically processing a termination of a virtual supercomputer daemon on a member computer in a virtual supercomputer while the virtual supercomputer is solving a computationally intensive problem, said method comprising the steps of:
(a) detecting the termination of the virtual supercomputer daemon;
(b) instructing the member computer to restart the virtual supercomputer daemon;
(c) instructing the member computer to restart the slave application;
(d) providing an initial data set to the member computer;
(e) instructing the member computer to perform a self-test using the initial data set;
(f) instructing the member computer to continue performing computational tasks for a previously assigned task quanta.

55. The method of claim 54 further comprising the steps of:
(a) receiving a self-test result from the member computer;
(b) instructing the member computer to terminate the slave application if the self-test is not successful;
(c) redistributing a computational load on the virtual supercomputer; and
(d) removing the member computer from the virtual supercomputer if the self-test is not successful.

56. The method of claim 55, wherein the step of redistributing a computational load on the virtual supercomputer comprises the steps of:
(a) determining which of a plurality of task quantum was previously assigned to the member computer;
(b) determining a computational capability for each member computer in the virtual supercomputer; and
(c) assigning a subset of the plurality of task quantum to each member computer in the virtual supercomputer.

57. A system for solving a computationally intensive problem using a virtual supercomputer, said system comprising:
(a) a virtual supercomputer comprising a master computer in communication with at least one slave computer;
(b) a master application running on the master computer; and
(c) a slave application running on the at least one slave computer;
wherein the master application divides the computationally intensive task into a plurality of task quantum and distributes a subset of the plurality of task quantum to the at least one slave computer, and wherein the slave application performs computations on the subset as directed by the master computer.

58. The system of claim 57, wherein the communication between the master computer and the at least one slave computer comprises a local area network.

59. The system of claim 57, wherein the communication between the master computer and the at least one slave computer comprises a wide area network.

60. The system of claim 57, wherein the communication between the master computer and the at least one slave computer comprises the Internet.

61. The system of claim 57, wherein the master application is adapted to receive periodic messages from the slave application, and wherein in response to the periodic messages, the master application performs a load balancing procedure on the virtual supercomputer.

62. The system of claim 57, wherein the master application detects the availability of a new slave computer and dynamically reconfigures the virtual supercomputer to incorporate the new slave computer in solving the computationally intensive problem.

63. The system of claim 57, wherein the computationally intensive problem comprises optimization of a financial portfolio.

64. The system of claim 57, wherein the computationally intensive problem comprises optimization of supply chain logistics.

65. The system of claim 64, wherein the computationally intensive problem further comprises determination of optimal stock levels on a by-item, by-store basis, together with a corresponding trans-shipment plan on a daily basis.

66. The system of claim 57, wherein the computationally intensive problem is used in conjunction with a branch-and-bound approach to optimization.

67. The system of claim 57, wherein the computationally intensive problem is used in connection with large-scale simulations to reduce total run time.

68. The system of claim 57, wherein the computationally intensive problem comprises network optimization problem.

69. The method of claim 68, wherein the network optimization problem comprises a vehicle routing and scheduling system.

70. The system of claim 57, wherein the computationally intensive problem comprises database searching across a network of workstations.

71. The system of claim 57, wherein the computationally intensive problem comprises database mining across a network of workstations.

72. The system of claim 57, wherein the computationally intensive problem comprises an image analysis program.
